(19) United States
(12) Patent Application Publication
(10) Pub. No.: US 2014/0134507 A1
(43) Pub. Date: May 15, 2014

(54) Humidifier, in Particular for a Fuel Cell

(71) Applicant: MANN+HUMMEL GMBH, Ludwigsburg (DE)

(72) Inventor: Michael Fasold, Auenwald (DE)

(73) Assignee: MANN+HUMMEL GMBH, Ludwigsburg (DE)

(21) Appl. No.: 14/080,914

(22) Filed: Nov. 15, 2013

(30) Foreign Application Priority Data
Nov. 15, 2012 (DE) 10 2012 022 349.8

(51) Int. Cl. H01M 8/04

(52) U.S. Cl. CPC H01M 8/04149
USPC 429/413; 261/104

(57) ABSTRACT

A humidifier has a housing in which a moisture exchanger is arranged. The moisture exchanger has water-permeable and/or water-vapor permeable hollow fibers. The hollow fibers separate a first flow path and a second flow path from each other. A spacer secures the hollow fibers in a defined position within the housing. The spacer contains a moisture storage medium that is at least partially made of a superabsorbent material.

### CROSS-REFERENCE TO RELATED APPLICATION

This application claims the benefit of German patent application no. DE 10 2012 022 349.8, filed Nov. 15, 2012, the entire contents to DE 10 2012 022 349.8 incorporated herein by reference.

### BACKGROUND OF THE INVENTION

The invention concerns a humidifier, in particular for a fuel cell, comprising a moisture exchanger with several water-permeable and/or water vapor-permeable hollow fibers arranged in a housing and separating a first flow path from a second flow path. The humidifier further comprises a spacer that secures the hollow fibers in a defined position within the housing.

In WO 2006/136231 A1 a humidifier is disclosed that comprises a hollow fiber arrangement of a plurality of parallel extending water vapor-permeable hollow fibers arranged in a housing. A first air stream flows within the hollow fibers in axial direction, a second air stream flows outside of the hollow fibers in radial direction relative to the longitudinal axis of the hollow fibers, wherein a water vapor exchange from the air stream with higher water contents to the air stream with lower water contents occurs through the walls of the hollow fibers.

The hollow fibers are arranged in horizontal layers wherein stacked layers are separated from each other by a nonwoven layer or a foam material layer; these layers enable flow of air therethrough with minimal pressure loss.

### SUMMARY OF THE INVENTION

It is therefore an object of the present invention to provide with simple means a humidifier that has a high degree of efficiency.

In accordance with the present invention, this is achieved in that the spacer is designed as a moisture storage medium that at least partially is comprised of a superabsorbent material.

By means of the humidifier an air stream can be enriched with moisture. The humidifier is advantageously correlated with a fuel cell that has a cathode that is supplied with a fresh air stream that is enriched with moisture. The fresh air stream is taken in particular from the environment and is enriched with moisture. The moisture may originate from another air stream that has an increased moisture contents; this second air stream, for example, is the exhaust air stream of the fuel cell.

The humidifier comprises, arranged in a housing, a moisture exchanger that has several water-permeable and/or water vapor-permeable hollow fibers which inside the housing separate a first flow path from a second flow path. The air streams with increased water contents and reduced water contents, respectively, are guided along the first and second flow paths, respectively, wherein through the wall of the water vapor-permeable hollow fibers moisture from the air flow with higher water contents passes to the air stream with lower water contents. For example, the air stream with higher water contents is fed radially from the exterior onto the hollow fibers and, accordingly, the other flow path with the air stream which has initially a lower water contents flows in the interior of the hollow fibers. Basically, reverse flow directions are conceivable also in which by means of the hollow fibers the air stream with higher moisture contents is axially supplied and, radially external to the hollow fibers, the air stream with initially lower water contents is being passed through the humidifier. In any case, it is expedient that the air stream which flows outside of the hollow fibers within the housing has an orientation orthogonal or radial to the longitudinal extension of the hollow fibers.

In the housing of the humidifier there is a spacer which secures the hollow fibers in a defined nominal position within the housing. The spacer is configured as a moisture storage medium that is comprised, at least partially, of a superabsorbent material. Superabsorbent materials are capable of absorbing and binding moisture in a quantity that is a multiple of their own weight. As superabsorbent materials, for example, a superabsorbent polymer (SAP) is conceivable which is comprised of hydrophilic polymer fibers which can absorb water and swell when doing so. Desorption leads to release of the water. The hydrophilic fibers can be embedded optionally in a support nonwoven.

The use of the superabsorbent material in the spacer has a moisture-compensating function in that fluctuations in the moisture contents of the air stream that flows through the housing external to the hollow fibers can be compensated. The moisture is absorbed by the superabsorbent material and the moisture is released again only after saturation is reached whereupon, depending on the flow direction, the moisture is released either through the wall into the interior of the hollow fibers or is directly carried away from the housing. By means of the compensation function of the spacer with superabsorbent material, a more uniform moisture transfer is achieved.

When passing an air stream with high water contents through the humidifier that is fed radially from the exterior onto the hollow fibers, the efficiency can be moreover increased because by means of the superabsorbent material in the spacer a high proportion of the moisture contained in the fed-in air stream is absorbed while in embodiments of the prior art a relatively high proportion of the water contents will flow out of the humidifier again without transfer of the moisture to the second air stream. The superabsorbent material retains the moisture and releases it after reaching saturation whereupon the moisture can transfer through the membrane wall of the hollow fibers into the interior of the hollow fibers. The air in the second flow path that is now enriched with moisture is then carried away axially through the interior of the hollow fibers.

At the same time, the superabsorbent material has only a relatively minimal flow resistance so that the counter pressure that is produced by the spacer can be overcome by the fed-in air stream. The residual moisture which is still contained in the air stream that exits from the humidifier and has flowed through the housing external to the hollow fibers is significantly reduced in comparison to the prior art so that the efficiency of moisture transfer from the first air stream to the second air stream is improved.

Various embodiments of the spacer in the humidifier are conceivable. On the one hand, it is possible to fill all, or at least almost all, of the intermediate spaces between neighboring hollow fibers or between individual hollow fibers and the inner wall of the housing of the humidifier with the material of the spacer. Optionally, at individual positions the spacer can be embodied to have an increased proportion or increased density of superabsorbent material in order to improve absorption by this reinforcement at those locations where there is a higher risk of passage of the air stream without transfer of the moisture to the hollow fibers. Such a passage without moisture transfer is in particular present in the region near the inner housing wall.

In general, it is possible to provide in one, in two, or in all three spatial directions either a uniform proportion of superabsorbent material within the spacer or to provide in one or several of the spatial directions a non-uniform distribution or concentration of superabsorbent material within the spacer. Moreover, it is possible to produce the spacer only partially or completely of superabsorbent material. According to an alternative embodiment, it is provided on the other hand that the spacer has a defined proportion of superabsorbent material in that, for example, fibers of the superabsorbent material are embedded in a nonwoven support. In any case, the spacer has a satisfactory stiffness or strength in order to secure the hollow fibers at the defined and desired position within the housing of the humidifier.

The hollow fibers extend preferably straight and parallel to each other in the housing of the humidifier. It can be expedient to arranged the hollow fibers spaced apart from each other, respectively, which provides the possibility that the hollow fibers are enclosed completely by the material of the spacer. In a further embodiment, it is provided that the hollow fibers are positioned at a spacing relative to each other but are enclosed only partially by the material of the spacer. It can be expedient in case of a partial enclosure to provide at least an enclosing angle of 180 degrees in the circumferential direction.

According to a further alternative, the hollow fibers are positioned, at least within one layer, immediately next to each other wherein different layers are separated from each other by the spacer. In this way, a high density of hollow fibers is achievable.

According to a further embodiment, the spacer is embodied as a ply or a layer and is positioned between stacked layers of parallel arranged hollow fibers. In this context, for example, a straight spacer layer, a zigzag-shaped or an undulated spacer layer is conceivable wherein the zigzag-shaped or undulated spacer layer has the additional advantage that the hollow fibers not only in the direction of height but also in the transverse direction, i.e., transverse to their length extension, are stabilized by the spacer and secured at the predetermined location.

In a further embodiment, the hollow fibers are received in a membrane block in which also the spacer is integrated.

### BRIEF DESCRIPTION OF THE DRAWING

FIG. 1 shows in a schematic illustration a humidifier for a fuel cell, comprising a moisture exchanger that comprises hollow fibers with water-permeable walls.

FIG. 2 shows a humidifier in cross-section perpendicular to the longitudinal axis of the hollow fibers.

FIG. 3 is a schematic illustration of a further embodiment of a humidifier.

FIG. 4 shows a further embodiment of a humidifier.

In the Figures same components are identified with same reference characters.

### DESCRIPTION OF THE PREFERRED EMBODIMENTS

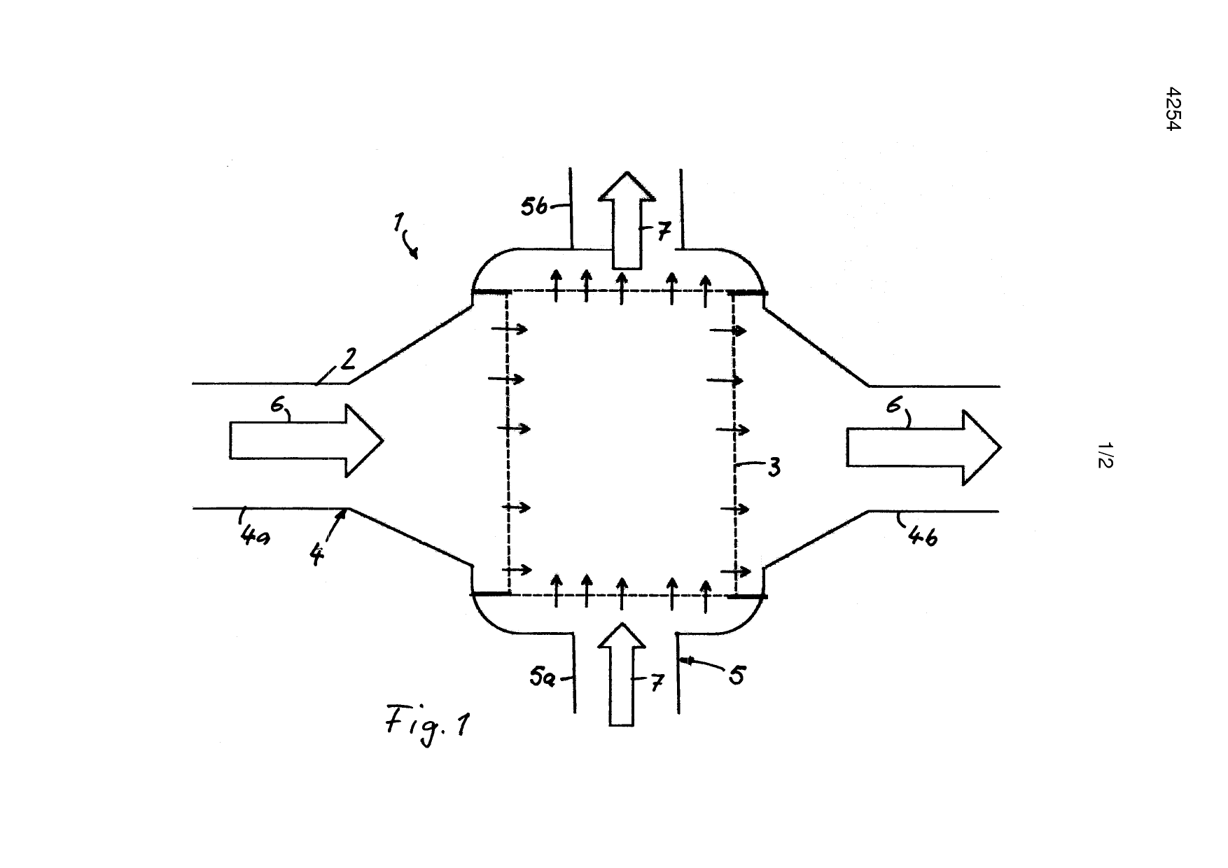

By means of a humidifier 1, schematically illustrated in FIG. 1, a moisture-enriched fresh air stream is supplied to a fuel cell; this air stream has a minimum moisture contents. The humidifier 1 comprises a cartridge 3 which is received in a housing 2 so as to be exchangeable or fixedly mounted and which transfers moisture that is contained in an exhaust gas stream onto a dry fresh air stream supplied to the fuel cell. The cartridge 3 has several hollow fibers whose walls are designed as water-permeable membranes.

By means of a fresh air passage 4 in the housing 2, the humidifier 1 is supplied with ambient air as fresh air that is passed through the hollow fibers. The fresh air passage 4 has a supply section 4a upstream of the cartridge 3 as well as a discharge section 4b downstream of the cartridge 3.

At a 90 degree angle to the fresh air passage 4, an exhaust gas passage 5 is provided in the housing 2 by means of which, as a further air stream, the exhaust gases of the fuel cell which are enriched with moisture are passed through the cartridge 3. The exhaust gas passage 5 has a supply section 5a upstream of the cartridge 3 and a discharge section 5b downstream of the cartridge 3. The air stream with the exhaust gases of the fuel cell flows radially against the walls of the hollow fibers.

Via the fresh air passage 4, a fresh air stream 6 is fed through the humidifier 1; the exhaust gas stream 7 which originates at the fuel cell is passed though the crossing exhaust gas passage 5. The crossing streams 6 and 7 are separated within the cartridge 3 by means of the water-permeable hollow fiber walls that are at least partially embodied as a gas-tight membrane; the hollow fibers permit only water exchange from the exhaust gas stream 7 laden with a high moisture contents to the dry fresh air stream 6. The fresh air passage 4 forms the supply passage for supplying fresh air that is enriched with moisture to the fuel cell while the exhaust gas passage 5 constitutes the exhaust gas flow path.

In FIG. 2, the humidifier 1 for a fuel cell is illustrated in a section view. The humidifier 1 has in the housing 2 a moisture exchanger with a hollow fiber block or membrane block 8 comprising a plurality of hollow fibers 9 and a spacer 10. The hollow fibers 9 extend parallel to each other and orthogonal to the air stream 7 which supplies the moisture-laden exhaust gas stream of the fuel cell. This exhaust gas stream is guided into the interior of the membrane block 8 and flows radially from the exterior against the walls of the hollow fibers 9.

The walls of the hollow fibers 9 are designed as water-permeable membranes through which water or water vapor contained within the air stream 7 can pass radially from the exterior into the interior of the hollow fibers. Through the hollow fibers 9, a fresh air stream is axially supplied which is enriched with the moisture originating from the exhaust gas stream 7.

The interior of the membrane block 8 is filled with the material of the spacer 10 that contains a proportion of superabsorbent material (SAP) which can absorb a high moisture content. The superabsorbent material is, for example, embodied as a superabsorbent polymer (SAP) which comprises hydrophilic polymer fibers. The spacers 10 are comprised either completely of the superabsorbent polymer SAP or contain a proportion of superabsorbent polymer SAP.

At the same time, by means of the spacer 10 the position of the hollow fibers 9 within the membrane block 8 is securely fixed. The hollow fibers 9 are positioned at a spacing relative to each other as well as at a spacing to the inner walls of the housing 2 and are completely enclosed by the material of the spacer 10. The entire free interior space in the membrane block 8, with the exception of the hollow fibers 9, is filled with the material of the spacer 10. In this way, it can be expedient to provide certain zones with an increased proportion or a higher density of superabsorbent material, for example, regions between the inner wall of the housing 2 and the next hollow fibers 9.

The moisture in the radially supplied air stream 7 is absorbed first by the superabsorbent material in the spacer 10. As soon as the degree of saturation in the superabsorbent material is reached, the moisture of the superabsorbent material is released gradually so that a more uniform moisture release is achieved. Also, the proportion of residual moisture which is still contained in the air stream 7 exiting from the membrane block 8 is reduced so that by means of the superabsorbent material in the spacer 10 an improved efficiency for the moisture transfer from the supplied air stream 7 onto the fresh air stream 6, guided within the interior of the hollow fibers through the humidifier 1, is achieved.

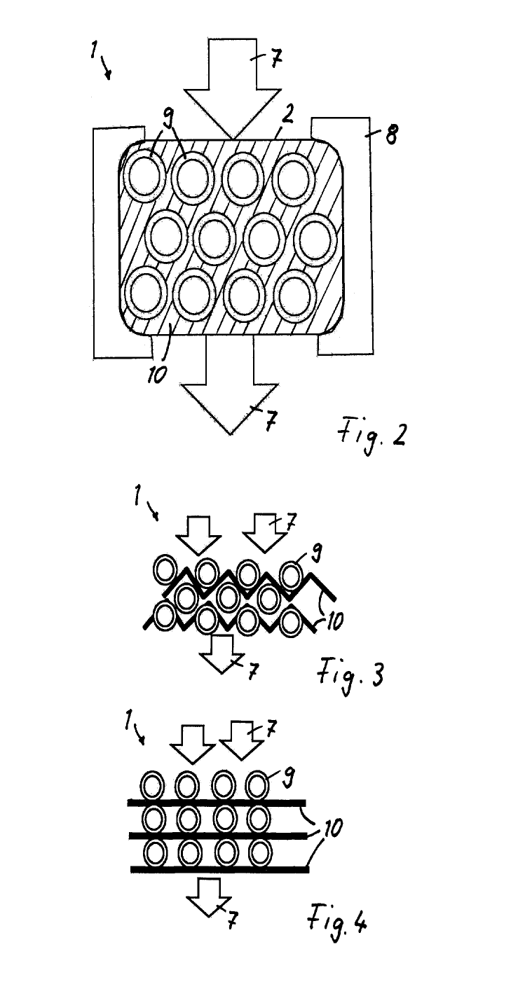

FIG. 3 shows a further embodiment in which the spacer 10 is embodied as a ply or a layer and has a zigzag shape. A spacer 10 extends between two stacked layers of parallel arranged hollow fibers 9, respectively. Due to the zigzag shape of the layer-shaped spacer 10 an excellent stabilization of the hollow fibers 9 in transverse direction, i.e., transverse to the longitudinal axis of the hollow fibers, is achieved.

In the embodiment according to FIG. 4 the spacers 10 are also embodied as a ply or a layer but straight or flat and form thus each a plate between layers stacked on each other of several parallel extending hollow fibers 9.

While specific embodiments of the invention have been shown and described in detail to illustrate the inventive principles, it will be understood that the invention may be embodied otherwise without departing from such principles.

What is claimed is:

1. A humidifier comprising:
a housing;
a moisture exchanger arranged in the housing;
the moisture exchanger comprising water-permeable and/or water-vapor permeable hollow fibers, wherein the hollow fibers separate a first flow path and a second flow path from each other;
a spacer securing the hollow fibers in a defined position within the housing;
the spacer comprising a moisture storage medium that is at least partially comprised of a superabsorbent material.

2. The humidifier according to claim 1, wherein the hollow fibers are arranged at a spacing relative to each other, respectively, and the spacer comprised of the superabsorbent material is positioned between the hollow fibers.

3. The humidifier according to claim 1, wherein all of the hollow fibers are positioned at a spacing relative to each other and relative to an inner wall of the housing and are secured in position by the spacer.

4. The humidifier according to claim 1, wherein at least one of the hollow fibers is at least partially enclosed by the spacer.

5. The humidifier according to claim 1, wherein at least one of the hollow fibers is completely enclosed by the spacer.

6. The humidifier according to claim 1, wherein within the housing a free interior space is provided between the hollow fibers and between the hollow fibers and the inner wall of the housing, wherein the free interior space is completely filled with the spacer.

7. The humidifier according to claim 1, wherein the spacer is a spacer layer arranged between stacked layers of the hollow fibers.

8. The humidifier according to claim 7, wherein the spacer layer is straight.

9. The humidifier according to claim 7, wherein the spacer layer is a zigzag-shaped layer.

10. The humidifier according to claim 7, wherein the spacer layer is an undulated layer.

11. The humidifier according to claim 7, wherein the spacer layer comprises fibers made of the absorbent material and said fibers are arranged randomly between the hollow fibers.

12. The humidifier according to claim 1, comprising a membrane block wherein the hollow fibers and the spacer are enclosed in the membrane block.

13. A fuel cell comprising a humidifier according to claim 1.
